(19) United States
(12) Patent Application Publication
(10) Pub. No.: US 2015/0290923 A1
(43) Pub. Date: Oct. 15, 2015

(54) APPARATUS AND PROCESS

(71) Applicant: AMCOR LIMITED, Hawthorn, VIC (AU)

(72) Inventor: Stephen Treloar, Queensland (AU)

(21) Appl. No.: 14/005,873

(22) PCT Filed: Jul. 10, 2013
(86) PCT No.: PCT/AU2013/000764

§ 371 Date: Sep. 18, 2013

Related U.S. Application Data
(60) Provisional application No. 61/673,586, filed on Jul. 19, 2012.

(30) Foreign Application Priority Data
Jul. 10, 2012 (AU) 2012902959

(51) Int. Cl. B41F 3/54

(52) U.S. Cl. CPC B41F 3/54

(57) ABSTRACT

The present invention relates to an apparatus, process and set of plates for printing. For example, the present invention can relate to a single printing station in which a first cylinder having a printing plate with an inked region operates with the second cylinder having at least one transfer plate, and suitably multiple transfer plates such as rubber blankets, wherein the transfer plates are adapted so as to have an inked region and a non-inked region. The inked region and the non-inked region of the transfer plate registering with the inked region of the printing plate so as to determine the content of the image printed.

### FIELD OF THE PRESENT INVENTION

The present invention relates to an apparatus, a set of printing plates and a process for printing. The present invention can be used to print onto any substrate including, but by no means limited to, continuous webs such as rolls of paper and plastic, and discrete substrate items such as preformed or partially pre-formed cans, bottles, caps and containers.

### BACKGROUND OF THE PRESENT INVENTION

Printing in an industrial context may be performed in various ways, including stamp printing, offset printing, gravure printing, screen printing and inkjet printing.

In the case of offset printing, ink is first applied to a printing plate that is rendered with regions that receive ink. Ink is transferred from a printing plate onto the printing cylinder having a rubber blanket, and the ink is then transferred from the rubber blanket onto the substrate to print the image. In lithographic offset printing, the printing plate has lithographic properties in which the regions of the plate having an affinity for oily ink are hydrophobic, and regions that do not have an affinity for oily ink are hydrophilic and as such, have an affinity for water. Oily ink and water are typically applied to the printing plate either directly or via one or more feed rollers immersed in baths of ink or water that also contact the plate.

A variation of offset printing is ‘dry offset’ printing, in which dry flowable ink that is “free” of water is applied to raised portions of the printing plate. For example, ink that is “free” of water may include a level of solvent so as to be flowable and is applied to raised flexographic printing surfaces which transferred ink onto the offset blanket, and from there onto the substrate.

In the case of gravure printing, a cylinder is etched according to the desired image so that parts of the cylinder have a capacity to carry and apply ink. Typically, the gravure roller is used to directly apply ink to the substrate. It is possible, however, for the gravure roller to transfer ink to a transfer cylinder which then prints the image onto the substrate. In either form of gravure printing, the content of the image is ultimately determined by inked regions of the gravure cylinder.

The above techniques are all economically viable in different circumstances and for different reasons. The techniques are, however, adapted for printing the same content onto a large numbers of products. One of the challenges facing manufacturers is to economically produce smaller numbers of products having individualised printed contented.

At present, the conventional printing practice is to manufacture different offset printing plates and gravure rollers to print different images. Alternatively inkjet printing can be used but this usually more costly than offset or gravure printing.

It is an object of the present invention to provide an alternative apparatus, process and set of printing plates.

### SUMMARY OF THE PRESENT INVENTION

The apparatus according to the present invention includes:
a first cylinder having a first inked region that receives ink from an ink source; and
a second cylinder having a second inked region and a second non-inked region, wherein the first and second cylinders are operable so that the second inked region of the second cylinder receives ink from the first inked region of the first cylinder, and the second non-inked region of the second cylinder at least partially registers with the first inked region of the first cylinder, yet the second non-inked region is adapted to prevent ink from transferring from the first inked region to the second non-inked region;
wherein the image printed is determined by the parts of the first inked region and the second inked region that register.

One of the main differences with previous printing apparatus and processes is that the image printed does not correspond with the ink region of the first. In accordance with the present invention, the second non-inked region also plays a part in the image that is printed.

Throughout this specification, the reference to the non-inked region of the second cylinder refers to a region that is adapted so as not to receive ink even if the non-inked region makes contact with an inked region of the first cylinder. In one example, the second non-inked region may be incapable of receiving ink.

The second cylinder may have multiple transfer plates, such as rubber blankets, for printing different images. Suitably, the transfer plates have either one or a combination of different second non-inked regions or different second inked regions, and therefore adapted to print different images using the same inked regions of the first cylinder. In other words, different images may be printed when the second cylinder has either different inked regions or non-inked regions, yet the first inked region that transfers ink to each plate can be the same. Ideally, the entire surface of the transfer plates is capable of the receiving ink from the first inked region of the first cylinder, save for the second non-inked region. The second non-inked region is suitably adapted so not to receive, or is unable to receive ink from the first inked region even though part of the second non-inked region registers with the first inked region.

Suitably, the second cylinder has multiple transfer plates and one or more of the transfer plates include an inked region or non-inked region that is uncommon to all of the transfer plates for printing different content.

One of the advantages of this aspect is that the cost incurred in shutting down the printing press to fit offset or gravure plates for each different image is avoided. The additional cost of manufacturing separate plates of different images is also avoided.

Suitably, the multiple transfer plates are discrete separate transfer plates for printing images onto separate substrates. Either one or a combination of the inked region of the transfer plates may differ, or the non-inked region of the transfer plates may differ. In one example, up to twenty transfer plates or rubber blankets may be fitted to the second cylinder. However, suitably from the six to twelve transfer plates may be fitted to the second cylinder, and at least two and suitably all have a different inking region or a different non-inking region. It is also possible that the multiple transfer plates may be interconnected together or integrally formed transfer plates.

It is also within the scope of the present invention that the second cylinder may have only one transfer plate. In this instance, transfer plates may be interchanged on the second cylinder to change the imaged printed.

In an alternative embodiment, the inked region of the second cylinder may be an outermost surface of the cylinder. However, it is preferred that inked region of the second cylinder be an outermost surface of a transfer plate that is fitted to the second cylinder, wherein the transfer plate is in the form of a rubber blanket. The non-inked region may be recessed inwardly of the outermost surface. The non-inked region may be cut away or recessed from the outermost surface using any suitable means, for example laser cutting, etching, high pressure cutting such as water blasting, routing, drilling, engraving or moulding.

The inked region of the second cylinder may have a higher affinity for ink than the non-inked region of the second cylinder. For example, when oily ink is used, the inked region may be hydrophobic, whereas the non-inked region may be hydrophilic.

The different images printed on the substrate can include some different content and some content that is the same, namely, the same content or common content. Depending on whether the image printed utilises background (negative) printing or foreground (positive) printing in the images, the different content may be either formed by either one or a combination of inking region or by non-inked region of the second cylinder. In particular, when the different content in the images being printed is background (negative) printing, the non-inked region of the second cylinder can represent the unique content of the image. The “surrounding” of the background will correspond to parts of the first and second inked regions of the respective cylinders registering. As explained above, the entire transfer plate may be an inked region, save for the part that is non-inked.

The second cylinder may have at least two the transfer plates that have different non-inked regions. In this situation the different content of the images is a negative image. In this situation, the inked region of the second cylinder, e.g., the region that is capable of receiving ink, may be a outer face of the transfer plate.

The second cylinder may also have two or more of the transfer plates that have different inked regions. In this situation the different content of the images is formed by a positive image. In other words, the first inked region of the first cylinder can form a “surrounding” part for each different image, and the second non-inked region of each second cylinder defines the different negative content of the images printed. The non-inked region of the second cylinder could also form at least part of the same content in the images.

In another example, the first cylinder has an inked region that can form a positive part for each different image, and the second cylinder has different inked regions which provide the different content of the images. The inked region of the second cylinder could also form at least part of the same content in the images.

Either one or a combination of the inked region or the non-inked region of the second cylinder may include a printing registration for monitoring the relative locations of the different content of the images to the same content of the images. The printing registration may also be used for monitoring the location of the image on the substrate, whether it be the different content or the same content.

The first inked region of the first cylinder may be adapted for printing the same images repeatedly on the substrate. The first inked region may, for example, be provided over two or more printing plates for the first cylinder.

When only one printing plate is provided on the first cylinder, the first inked region of the printing plate may transfer ink to the inked region of the transfer plate(s) of the second cylinder.

The first cylinder may also have multiple printing plates, in which case the printing plates may have the same first inked region that can register with the second inked region or the second non-inked regions of the second cylinder.

The inked region of the first cylinder may be gravure, lithographic or a hybrid thereof. For example, the inked regions may have an affinity for oily ink i.e. hydrophobic, or the surface of the first cylinder may be etched.

The first cylinder may also have non-inked region, for example a hydrophilic region or raised surface(s) disposed outwardly of the inked region.

The substrate may be a continuous web, and after printing on the web, the web may be converted into separate sections. The substrate may also be in the form of discrete items including containers, such as cans or bottles that have been partially or completely preformed prior to being printed on.

The apparatus may also include a feeder that conveys substrate so as to contact the second cylinder to print an image onto the substrate.

The feeder may include a support cylinder that forms a nip with the second cylinder through which the substrate is conveyed.

The support cylinder may include recesses about the perimeter thereof that are adapted to receive and orient individual substrate items in an orientation suitable for printing. The support cylinder may also have a drive that can at least partially rotate the substrate located in the recesses.

The present invention also relates to a process of printing different images onto substrate using a printing press having a first cylinder with a first inked region that can receive ink from an ink source, and a second roller having a second inked region and a second non-inked region, wherein the process includes the steps of:
a) transferring ink from an ink source onto a first inked region of the first cylinder; and
b) operating the first and second cylinders whereby ink is transfers from the first inked region to the second inked region, and the second non-inked region at least partially registers with the first inked region, yet the second non-inked region is adapted to prevent ink from transferring from the first inked region to the second non-inked region; and
c) applying the ink of the second inked region of the second cylinder to a substrate so that the image printed is determined by parts of the first inked region and the second inked region that register.

In an embodiment, the second cylinder has multiple transfer plates, and at least two of the transfer plates have either one or a combination of different second non-inked regions or different second inked regions, such that step b) includes registering different inked or non-inked regions of the second cylinder with the same inked region of the first cylinder so as to print different images from the at least two respective transfer plates.

In the situation in which the second cylinder includes “N” number of the transfer plates having different inked regions, one revolution of the second cylinder can print “N” number of different images. For example, “N” may be as high as 20 or 30. Suitably however, “N” is in the range of 6 to 12.

Step c) may include conveying discrete items of the substrate such as individual containers on which the different images are printed. Examples include cans such as beverage cans and bottles such as PET bottles.

Suitably, the first cylinder has two or more printing plates. Although it is possible that the printing plates may have different inking regions, suitably the printing plates have the same inked regions. In the case that the printing plates have the same inked regions, the second cylinder may have multiple transfer plates having different inked regions and step b) may include transferring ink from the inked regions of the first cylinder to different inked regions of the transfer plates to print images having different content corresponding to each different transfer plate. Step b) may also include transferring ink from the inked regions of the first cylinder and the transfer plates having different non-inked regions to print images having different content corresponding to the each different transfer plate.

The process may also include monitoring the relative locations of the different content of the images to the common content of the images.

The process may also include monitoring the location of the different content of the images on the substrate.

Monitoring the locations of the different and common content of the images may include printing registration demarcations. The registration demarcations may be in the form of monitoring the location of non-inked regions or the inked regions on the substrate.

In the situation in which the first cylinder includes two or more inked regions, for example, provided by two or more printing plates, each for printing a specific colour. In this situation, monitoring the location of image content printed in a first colour may be determined relative to the location of the image content printed in a second colour. For example, the different content is printed in the red, for example, monitoring the location of the different content may be carried out relative to the location of common content, printed in black ink, for example.

One of the advantages of the process is that discrete items having varying images can be produced and the degree of repetition of the images on consecutive products or within groups of products is relatively low compared to past practices. Moreover, in order to obtaining discrete products having a mixture of the printed images has in the past required that the product from separate printing runs be intermixed. This step has in some instances being carried manually, which can be labour intensive, and may not produce the same level of the intermixing of product.

The present invention relates to a set of plates that are used in a single stage of a printing press for printing content onto substrate, the set of plates including: a printing plate for a first cylinder of the printing press, the printing plate having a first inked region that can receive ink from an ink source;
at least one transfer plate for a second cylinder of the printing press that can print an image onto the substrate, and wherein the transfer plate has:
   a second inked region that can register with the first inked region, and when the printing plate and transfer plate are operably attached to the respective first and second cylinders, ink can transfer from the first inked region of the printing plate to the second inked region of the transfer plate, and
   a second non-inked region that can register with at least part of the first inked region of the printing plate when operated, yet the second non-inked region is adapted to prevent ink from transferring from the first inked region to the second non-inked region,
and an image is able to printed by the parts of the first inked region and second inked region that register in operation.

Ideally, the set of plates includes multiple transfer plates for attachment to the perimeter of the second cylinder, and either one of or combination of i) the second inked regions of at least two fo the transfer plates are different or ii) the second non-inked regions of at least two of the transfer plates are different, such that the image that can be printed by the transfer pleates is onto the substrate is different.

Although it is possible that the set of plates may have multiple printing plates that have different first inked regions, ideally the set of plates has multiple printing plates that have the same first inked regions.

The present invention relates to an apparatus for printing content onto substrate, the apparatus including:
a first roller/plate having first inking regions to which ink can be applied;
a second roller/plate that contacts the first roller/plate, the second roller/plate having second inking regions that align with the first inking regions of the first roller so as to able to receive ink from the first roller in the first region, and second non-inking regions that, when in use, register with at least part of the first inking regions, wherein at least part of the second non-inking region aligns with the first inking region of the first roller and is adapted to prevent ink from being transferred to the second non-inking region of the first roller; wherein ink from the second roller can be applied to substrate to print first content; and
a third roller/plate having a third inking region that registers with at least part of the first inking regions and thereby receives ink from the first roll, and ink in the third inking region can be applied to substrate to a print a second content that is different to the first content.

The various features described above in respect of one of the apparatus, the set of the plates, or the process may also be features of the other. For example, apparatus features described above may also be features of the process or the set of plates and vice versa.

### BRIEF DESCRIPTION OF THE DRAWINGS

An embodiment of the present invention will now be described with reference to the accompanying drawings, of which:

FIG. 1a is a schematic illustration of a printing plate that can receive ink from an ink source;

FIG. 1b is a schematic illustration of two transfer plates, such as rubber blankets, for applying ink to a substrate, the transfer plates being operable with the single printing plate shown in FIG. 1a for printing different images;

FIG. 1c is a schematic illustration of a transfer plate, such as a rubber blanket, for applying ink to a substrate, the transfer plate being operable with the single printing plate shown in FIG. 1a for printing a different image;

FIG. 1d is a schematic illustration of two containers, each container having a different images that are printed, for example, using the printing plate and transfer plates shown in FIGS. 1a and 1b;

FIG. 2 is a schematic illustration of an apparatus and process for printing images on substrate, for example in the form of individual containers, the images including common content that is present in the printing plates such as the word “BRAND”, and special different content that is not common to all of the transfer rollers and print different content onto each of the different transfer cylinders; and

FIG. 3 is a schematic side view of an apparatus and process according to another embodiment in the form of a decorator including i) a printing press having printing plates and blankets such as those illustrated in FIGS. 1a and 1b, ii) upstream stages such as a feed chute for feeding containers such as cans to the printing press, and iii) downstream stages such as a coater.

### DETAILED DESCRIPTION

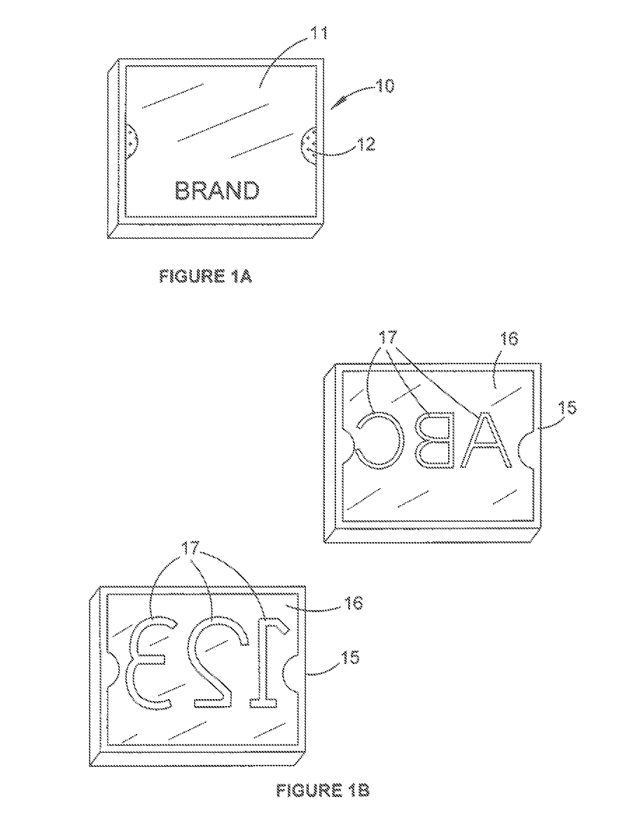

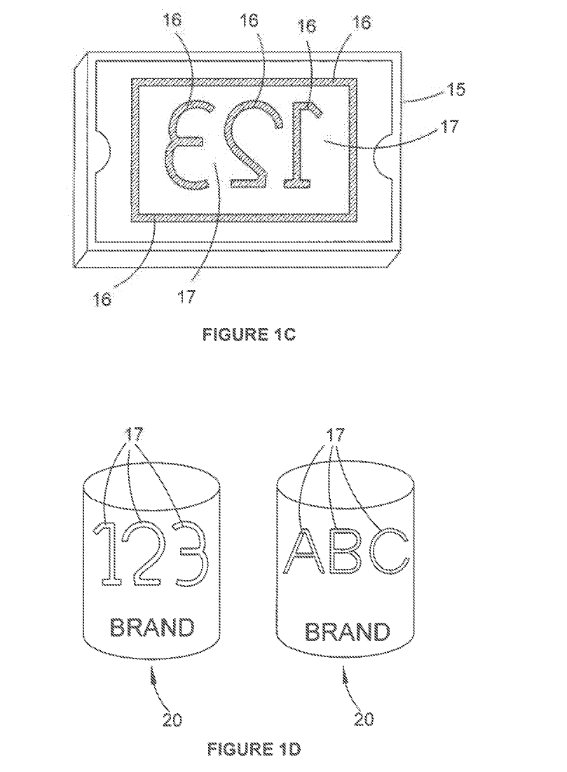

With reference to the drawings, FIG. 1a is an example of the conventional dry offset printing plate 10, which may for example, have one or more inked regions 11 that is capable of being inked. Within the inking regions 11, generally identified by the diagonal lines in FIG. 1a, the coverage of ink can range from being heavily inked to having little ink, or no ink. For example, the diagonal lines may represent a single background tone or text. The printing plate 10 also has common content, such as the “BRAND” of a product.

In the case of the example shown in FIG. 1a, the content of the image represented by the diagonal lines and/or the “BRAND” are printed in a single colour on account that they are provided on a single printing plate. In one example, the content such as an ingredients list and the BRAND may be printed in one colour such as red. In any event, the “BRAND” and diagonal lines represent content in one colour, a part of which may be common to each image print.

The non-inking region(s) 12 of the printing plate 10 are generally identified by the star symbols shown in FIG. 1a.

It will be appreciated that it is possible that the indica or content represented by the diagonal lines and the “BRAND” may also be printed in different colours, in which case, separate printing plates (not illustrated in FIG. 1a), one for each colour, will have distinctive inked regions 11 and non-inked regions 12.

It is also possible that the offset printing plate 10 may be etched, such as a gravure printing plate in which the degree of etching on the plate determines the capacity for the plate to hold ink. Alternatively the printing plate 10 may be in the form of a lithographic printing plate.

FIG. 1b illustrates two examples of transfer plates 15, such as rubber blankets, that transfer ink from the printing plate to the substrate on which the image is printed. The transfer plates 15 having inked regions 16 that correspond to the content of the image to be printed which conforms, at least partially or possibly completely, with the inked region of the printing plate 10. In other words, when the printing plate 10 and transfer plates 15 are fitted to cylinders of a printing press and the cylinders operated, the inked region 16 of the transfer plates 15 receives ink by registering with at least part of the inked region 11 of the printing plate 10. It is also possible that the inked region 16 of one of multiple transfer plates 15 being used registers with the inked region 11 of the printing plate 10.

Non-inked regions 17 of individual transfer plates 15 can be specifically adapted to reflect the unique content to be printed by each transfer plate 15. The unique content can be printed as a “negative” i.e., the lack the ink transferred to the non-inking regions of the transfer plate representing the unique content of the image being printed. It will be understood that the term “negative” in this context embraces the absence of ink from an otherwise printed or “positive” printed part of the image. It will be understood, that the term “positive” in this context embraces the application of ink to the substrate.

In the case of the FIG. 1b, the non-inked regions 17 are in the form of etched symbols, namely, numbers 1 2 3 and letters A B C on the rubber blanket. The etched symbols do not make contact with the printing plate 10 when in use, such that the unique content of the image printed by the transfer plates 15 is a negative of the respective numbers and letters.

In another example, it is also possible that the non-inked regions 17 of the transfer plates 15 may have some other form of adaptation, for example hydrophobicity, that stops ink being transferred the non-inked regions of the transfer plates 15.

Ink applied to the sub-sections of the inked regions 11 of the printing plate 10 that do not register with the inked regions 16 of the transfer plates 15 may be retained in the inked region 11 until the inked region 11 registers with an ink region of another transfer plate 15. In this situation, less ink will be “re-applied” to the sub-section of the ink region 11 of the printing plate 10 between each inking step of the printing plate 10. In addition, as the non-inked regions 17 of the transfer plates 15 may differ from one transfer plate to the next, the inked region of the printing plate 10 may also register and transfer ink to different inked regions of the transfer cylinder.

FIG. 1c illustrates a transfer plate 15, such a rubber blanket in which inked region 16 is adapted to receive ink from the printing plate shown in FIG. 1a. The non-inked regions 17 are adapted, for example, be laser etched so that the different individual content of the transfer plate 15 forms the inked region 16. The ink region being raised relative to the non-inked region 17 can receive ink from the inked region of the printing plate 10 shown in FIG. 1a. FIG. 1c is an example of a printing plate 15 in which different content of the image, applied to the substrate by the inked regions 16 is “positive” image.

FIG. 1d is an example of substrate that may be in the form of containers 20, such as plastic or non-plastic containers including metallic cans on which the image printed on the substrate includes common elements, such as the word “BRAND” and content, such the letters “A B C” and numbers “1 2 3” which is the different content of the individual transfer plates 15 and, thus different content for the containers 20.

Although not illustrated in FIG. 1a, 1b or 1c, the printing plates 10 and the transfer plates 15 may have print registrations. Ordinarily print registrations are used to monitor the registration of different colours printed by different printing plates on the image. In the case of the present invention, the print registrations are used to monitor the location of the different print content relative to the common print content. For example, to ensure that the letters “A B C” and the numbers “1 2 3” are located on the substrate relative to the word “BRAND”.

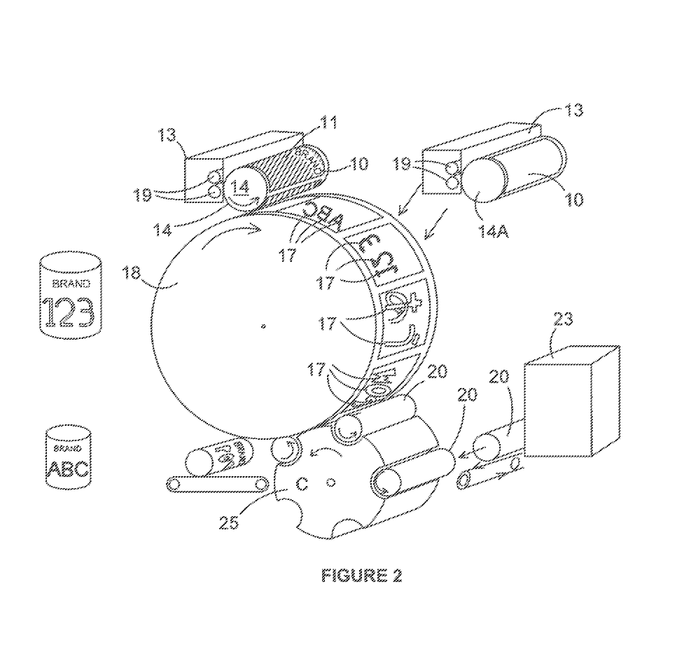

FIG. 2 is a schematic illustration of an apparatus and process for printing different images onto separate substrate items. The embodiment of the present invention illustrated in FIG. 2 is for printing four different images. However, it will be appreciated that it is within the scope of the present invention that any number of the different images can be printed using a corresponding number of transfer plates 15 (or rubber blankets) and one or more than one printing plate, depending on the size and configuration of the machinery used.

The embodiment includes an ink source 13, a first cylinder 14 having a printing plate 10, for example, the printing plate 10 illustrated in FIG. 1a, that receives ink from the ink source 13, and a second cylinder 18 having transfer plates 15, such as the transfer plates 15 shown in FIG. 1b. The embodiment also includes a feeder 22 that conveyors and positions substrate 20 relative to the second cylinder 18 for transferring ink from the second cylinder 18 onto the substrate 20. As can be seen, the substrate 20 is preferably in the form of a container such as a metal can.

The first cylinder 14 may have fitted thereto any number of printing plates 10 including only one printing plate 10, but preferably two or more than two printing plates 10.

Although it is possible that the printing plates 10 may differ in either one or a combination of the inked regions 11 or non-inked regions 12, ideally the printing plates 10 are the same in terms of the inked and non-inked regions 11, 12. Separate printing plates 15 may be used for printing each colour.

In the case of the embodiment shown in FIG. 2, the ink source 13 has a bath of oil based ink and a bath of water, rollers 19 submersed in the baths contact with the first cylinder 14 at a nip. The second cylinder 18 has multiple transfer plates 15 in the form of rubber blankets that align with the printing plates 10 of the first cylinder 14 when the first and second cylinders 14, 18 are operated. The second cylinder 18 ideally has more than four or five blankets, but may for example have 6, 8, 10, 12, 16 blankets arranged around the perimeter of the cylinder 18. As can be seen in FIG. 2, at least two of the blankets differ in either one or both of inked regions or non-inked regions 16, 17. In any event, the inked regions 16 of the blankets have at least some common inked regions, for example, for printing the same image one all of the containers. The image common to each container may be a logo, brand name or a list of ingredients, for example.

In the case of the embodiment shown in FIG. 2, the symbols illustrated on the blankets represent non-inked regions 17 that do not receive ink from printing plate of the first roller. For the purpose of schematically illustrating an embodiment, the area of the blankets other than the symbols is an inked region that receives ink from the printing plates.

The containers may be pre-manufactured at another manufacturing facility 23, or on the same site as the printing process. In either situation, printing onto the containers may be carried out consecutively with the manufacturing process, or disjunctively after manufacture thereof in which case the containers may be stored prior to the containers being printed.

The feeder 22 includes a conveyer 24 that transports the containers 20 from one location to another, for example from a manufacturing facility 20 to storage, to a supporting cylinder 25 that has recesses for the holding the containers 20 in an appropriate orientation for being printed on. As can be seen, ideally the longitudinal axis of the containers 20 extends in a direction of the blankets 15 of the second cylinder 18 and the supporting cylinder 25 rotates in the direction of arrow C to present the walls of the containers 20 to the blanket 15 for transferring ink therebetween. The containers 20 may be held stationary relative to the recesses of the feed cylinder. However, as illustrated in FIG. 2, the container may also be rotated about a longitudinal axis thereof so that the side walls around the perimeter of the side wall of the container can be printed.

As with the embodiment shown in FIGS. 1a, 1b and 1d, the image printed on the containers 20 shown in FIG. 2 can have a common content such as the “BRAND”, in which case each blanket 15 receives ink from the printing plate 10 and transfers this ink to the containers 20 for printing the common content. The non-inked regions 17, surrounded by inked regions 15, form the different content printed which is particular to the individual blankets 15. In another example, the common content may be a bar code or a quick response code. The common content may also be printed in another colour using, for example, the standard printing techniques in which a dedicated printing plate applies ink to rubber blanket in which the entire surface of the rubber blanket is adapted for receiving ink.

When the blankets 15 of the second cylinder 18 each have different non-inked regions 17, for example by engraving non-inked regions 17 below the inked regions, the same number of the containers 20 having different images can be produced by one revolution of the second cylinder 18. For example, when the second cylinder has 8 different blankets 15, one revolution of the second cylinder 18 can produce 8 containers having different images.

In the situation in which multiple colours are printed into the substrate, separate printing plates, each having their own inking source and plate cylinders 14 or 14A, can be arranged about the perimeter of the second cylinder 18 for apply different colour inks successively to the blankets 15 prior to transferring the all of the ink colours from the blankets 15 to the cans 20. This aspect is schematically illustrated in FIG. 2 by the second plate cylinder 14A would be positioned adjacent to the first plate cylinder 14. However for the purpose of maintaining clarity of FIG. 2, the second plate cylinder has been illustrated at a distance from the blanket cylinder 18 (as if in an exploded view).

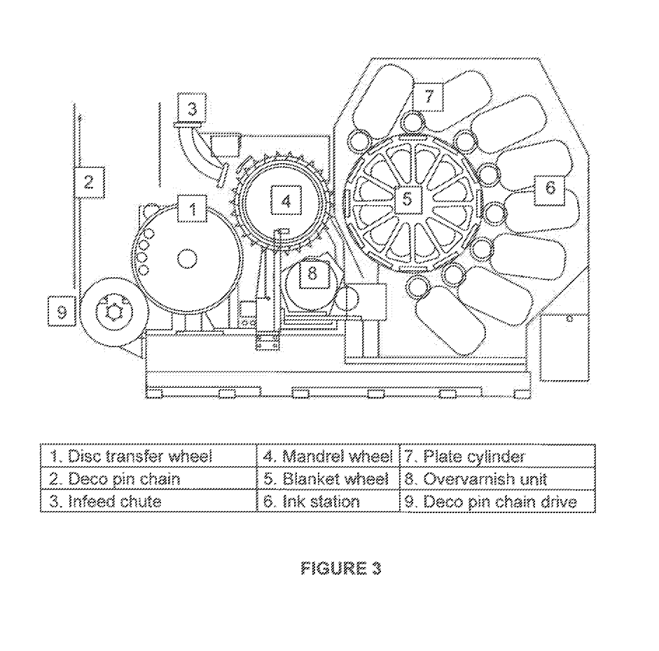

FIG. 3 illustrates an embodiment of an apparatus and process including a printing stage, an upstream stage for feeding containers such as cans to the printing stage, and a downstream stage including a varnishing unit. Specifically, the upstream stage includes an infeed chute 3 that feeds the containers onto a mandrel wheel 4, (equivalent to support cylinder 25 in FIG. 2). The mandrel wheel 4 has twenty four mandrels which receive a container from the infeed chute 3 and are adapted to drive rotation of the received containers, or allow free rotation of the containers within each mandrel. Containers on the mandrel wheel 4 contact the blankets fitted to the blanket wheel 5. Following application of ink, the mandrel wheel 4 rotates the inked container to the downstream stage which includes a varnishing unit, where an outer coating such a varnish can be applied to the containers. As can be seen, the varnishing unit includes one or more rollers to transferring varnish onto the outer surface of the containers. It is also possible that the varnishing unit may include a sprayer for spraying an outer coating onto the containers. From the varnishing unit, the containers are transferred to disc transfer wheel 1 for further processing, such as setting the ink and varnish.

The blanket wheel 5 of printing stage includes a total of twelve blankets that are arranged around the perimeter of the wheel 5. Eight plate cylinders 7, each having two printing plates are arranged around the blanket wheel 5. As the blanket wheel 5 rotates counter clockwise, each plate cylinder successively applies one colour of ink to the plates on the plate wheel 5. In the case of the embodiment shown in FIG. 3, a total of eight different colours can be applied to each blanket for transfer to the containers.

One or more of the wheels 1, 4, 8, 5 and cylinder 7 can be driven by a common pin chain drive 9. If necessary, separate drives may also be provided to one or more of the wheels 1, 4, 8, 5 and cylinder 7.

One of the advantages of the process and apparatus is that separate printing plates 10 are not required for each different image to be printed, thereby reducing production down-time compared to the conventional practice of having to manufacture and fit different printing plates 10 for each image. In the case of the embodiment shown in FIG. 2, numerous blankets, for example, up to 12 different blankets can be changed on the second roller, in a single shutdown period that would ordinarily be required to change the printing plates of the first cylinder 14. In one example, the different content may be a bar code or quick response code which may correspond to the particular product.

Another advantage is that each consecutive container 20 can have different printed content which means that when the containers 20 are then packaged, for example into block of twenty four or thirty containers 20, the package should have good mixture of the containers 20 with different images. An additional mixing step, be it performed manually or by automatic means can be avoided.

Those skilled in the art of the invention will appreciate that many variations and modifications may be made to the embodiments of the invention described herein without departing from the spirit and scope of the present invention.

For example, although the Figures illustrate embodiments in which the images printed differ in the form of different negative content, it is within the scope of the invention that the different content in the images may be in the form of positively printed content. In this situation it also possible for different images to include some common content, and the common content may be printed either positively or negatively in terms of the ink applied and the background.

In one embodiment of the invention, different images on the second printing blanket can be used to personalise packaging, for example being used to print different names on different copies of the packaging.

In one embodiment of the invention, the printing blanket can be used to print beverage cans with different names, for example “Dave” and “Sandra”, designed to encourage purchase of these beverage cans.

1.-36. (canceled)

37. An apparatus for printing an image including:
a first cylinder having a first inked region that receives ink from an ink source; and
a second cylinder having a second inked region and a second non-inked region, wherein the first and second cylinders are operable so that the second inked region of the second cylinder receives ink from the first inked region of the first cylinder, and the second non-inked region of the second cylinder at least partially registers with the first inked region of the first cylinder, yet the second non-inked region is adapted to prevent ink from transferring from the first inked region to the second non-inked region;
wherein the image printed is determined by the parts of the first inked region and the second inked region that register.

38. The apparatus according to claim 37, wherein the second cylinder includes multiple transfer plates, and the transfer plates have either one or a combination of: i) different second non-inked regions or ii) different second inked regions for printing different images, such that the images printed by at least two of the transfer plates have different content.

39. The apparatus according to claim 38, wherein the second cylinder includes “N” number of the transfer plates having different inked regions or non-inked regions, and one revolution of the second cylinder prints “N” number of different images.

40. The apparatus according to claim 38, wherein the inked region and non-inked region of the transfer plates represent different indicia that forms different content of the images of the transfer plates.

41. The apparatus according to claim 38, wherein the second non-inked region of the transfer plates is recessed from the second inked region of the transfer plate.

42. The apparatus according to claim 38, wherein the second non-inked region of the transfer plate is cut away so as to be recessed below the outermost surface of the transfer plate.

43. The apparatus according to claim 38, wherein the second inked region of the transfer plates is hydrophobic and the second non-inked region is hydrophilic, and thereby the inked region has a higher affinity for oily ink.

44. The apparatus according to claim 38, wherein two or more of the transfer plates of the second cylinder have different inked regions or different non-inked regions so as to print images having some different content and some common content.

45. The apparatus according to claim 44, wherein when the different content in the images printed is background (negative) printing, the non-inked region of the transfer plates can represent the different content of the images.

46. The apparatus according to claim 44, wherein when the different content in the images is foreground (positive) printing, at least part of the second inked regions of the transfer plates represents the different content of the images.

47. The apparatus according to claim 38, wherein some of the same content of the images printed is background (negative) printing, and the non-inked region of the transfer plate represent at least part of the same content that is printed in the background.

48. The apparatus according to claim 38, wherein the transfer plates are rubber blankets.

49. The apparatus according to claim 38, wherein the first cylinder has multiple printing plates having the same first inked region.

50. The apparatus according to claim 38, wherein the first cylinder has multiple printing plates, and two or more of the printing plates have different first inked regions, and two or more than two different images can be printed on separate substrates that are fed through the apparatus.

51. The apparatus according to claim 49, wherein the first inked regions of the printing plates register with the second inked regions or the second non-inked regions of the multiple transfer plates.

52. The apparatus according to claim 49, wherein the printing plates are in the form of either a gravure printing plate, a lithographic printing plate or a hybrid thereof.

53. The apparatus according to claim 37, wherein the apparatus includes a feeder that conveys substrate to contact the second cylinder to print an image onto the substrate.

54. The apparatus according to claim 53, wherein the feeder is adapted for feeding substrate in the form of either i) a continuous web which after printing is converted into separate discrete items, or ii) discrete items including containers, such as cans or bottles, that have been partially or complete preformed prior to being printed on.

55. The apparatus according to claim 53, wherein the feeder includes a support cylinder that forms a nip with the second cylinder through which the substrate is conveyed.

56. The apparatus according to claim 55, wherein the support cylinder is adapted to receive and orient the individual substrate items in an orientation suitable for printing.

57. A process for printing different images onto substrate using a printing press having a first cylinder with a first inked region that can receive ink from an ink source, and a second cylinder having a second inked region and a second non-inked region, wherein the process includes the steps of:
a) transferring ink from an ink source onto a first inked region of the first cylinder;
b) operating the first and second cylinders whereby ink transfers from the first inked region to the second inked region, and the second non-inked region at least partially registers with the first inked region, yet the second non-inked region is adapted to prevent ink from transferring from the first inked region to the second non-inked region; and
c) applying the ink of the second inked region of the second cylinder to a substrate so that the image printed is determined by parts of the first inked region and the second inked region that register.

58. The process according to claim 57, wherein the second cylinder has multiple transfer plates, and at least two of the transfer plates have either one or a combination of different second non-inked regions or different second inked regions, such that step b) includes registering different inked or non-inked regions of the second cylinder with the same inked region of the first cylinder so as to print different images from the at least two respective transfer plates.

59. The process according to claim 58, wherein the second cylinder includes “N” number of the transfer plates having different inked regions or different non-inked regions, and one revolution of the second cylinder prints “N” number of different images.

60. The process according to claim 58, wherein the second cylinder has multiple transfer plates having different inked regions and step b) includes transferring ink from the inked regions of the first cylinder to different inked regions of the transfer plates to print images having different content corresponding to each different transfer plate.

61. The process according to claim 60, wherein step b) includes transferring ink from the inked regions of the first cylinder and the transfer plates having different non-inked regions to print images having different content corresponding to each different transfer plate.

62. The process according to claim 58, wherein when the different content in the images printed is background (negative) printing, the non-inked region of the transfer plates can represent the different content of the images.

63. The process according to claim 58, wherein when the different content in the images is foreground (positive) printing, at least part of the inked regions of the transfer plates represents the different content of the images.

64. The process according to claim 58, wherein two or more of the transfer plates of the second cylinder have different inked regions or different non-inked regions so as to print images having some different content and some common content.

65. The process according to claim 57, wherein the first cylinder has two or more printing plates which have the same inked regions.

66. The process according to claim 57, wherein applying ink to the substrate, includes feeding the substrate, such as preformed containers, into the printing press at a desired orientation so as to contact the second cylinder and print an image onto the substrate using ink from the second inked region.

67. A set of plates that are used in a single stage of a printing press for printing different image content onto substrate during a single continuous printing operation, the set of plates including:
a printing plate for a first cylinder of the printing press, the printing plate having a first inked region that is adapted to receive ink from an ink source;
a transfer plate for a second cylinder of the printing press that can print an image onto the substrate, and wherein the transfer plate has:
a second inked region that can register with the first inked region, and when the printing plate and the transfer plates are operably attached to the respective first and second cylinders, ink can transfer from the first inked region of the printing plate to the second inked region of the transfer plate, and
a second non-inked region that can register with at least part of the first inked region of the printing plate when operated, yet the second non-inked region is adapted so as to prevent ink from transferring from the first inked region to the second non-inked region,
and an image is printed by the parts of the first inked region and the second inked region that register in operation.

68. The set of plates according to claim 67, including multiple transfer plates for the second cylinder, and either one of or combination of i) the second inked regions of at least two respective printing plates are different, or ii) the second non-inked regions of at least two of the respective printing plates are different, such that the image that can be printed by the second plates onto the substrate is different.

69. The set of plates according to claim 67, including multiple printing plates that have the same first inked regions.

70. An apparatus for printing an image including:
a printing plate for a first cylinder, the printing plate having a first inked region that receives ink from an ink source; and
a two or more transfer plates for a second cylinder, the transfer plates having a second inked region and a second non-inked region, wherein the first and second cylinders are operable so that the second inked region of the transfer plates receives ink from the first inked region of the printing plate, and the second non-inked region of the transfer plates at least partially registers with the first inked region of the printing plate, and the second non-inked region of the transfer plate is cut away so as to be recessed below the outermost surface of the transfer plate to prevent ink from transferring from the first inked region to the second non-inked region;
wherein the image printed is determined by the parts of the first inked region and the second inked region that register.
